(19) United States
(12) Patent Application Publication
(10) Pub. No.: US 2008/0134067 A1
(43) Pub. Date: Jun. 5, 2008

(54) MODIFYING THE VISUAL APPEARANCE OF BOOKMARKS IN AN INTERNET BROWSER

(76) Inventors: Steven Francis Best, Georgetown, TX (US); Robert James Eggers, Austin, TX (US); Janice Marie Girouard, Austin, TX (US)

Correspondence Address: IBM CORP (YA);C/O YEE & ASSOCIATES PC, P.O. BOX 802333, DALLAS, TX, 75380, US

(21) Appl. No.: 11/566,450

(22) Filed: Dec. 4, 2006

(51) Int. Cl. G06F 3/048

(52) U.S. Cl. 715/765

(57) ABSTRACT

A computer implemented method and apparatus for modifying a visual appearance of bookmarks in an Internet browser. A bookmark and a state corresponding to a website are obtained. The bookmark is placed in a first folder associated with the Internet browser based on the state. Responsive to a user visiting the website and perform an action, the visual appearance of the bookmark in the first folder is modified based on the state and the action.

### BACKGROUND OF THE INVENTION

1. Field of the Invention

The present invention relates generally to a data processing system and in particular to a method and apparatus for managing bookmarks for a browser. Still more particularly, the present invention relates to a computer implemented method, apparatus, and computer usable program code for modifying the visual appearance of bookmarks in a browser.

2. Description of the Related Art

On the Internet, a website address is specified by a universal resource locator (URL). Each website has a unique universal resource locator. When a user visits a specific website, and the user desires to remember the universal resource locator for the website so that the user can revisit the website, the user typically bookmarks that site by placing the universal resource locator for that website in a special bookmark folder.

When a website changes, the user may be required to take specific actions. For example, a user who has a brokerage account for buying and selling stocks on the stock market may be required to acknowledge having read a user agreement. If the terms of the agreement change, then the user must re-acknowledge having read the new terms of the user agreement. Similarly, a corporation may ask employees to acknowledge having read a new or changed corporate policy, such as business conduct guidelines posted on a website.

Currently, when a user is required to visit a changed website and perform certain actions, the user is typically notified by an email. Notifying a user about various websites which the user should visit may result in the user receiving many emails as a result of various websites changing. Also, the bookmarks for the websites at which the user needs to visit and perform certain actions remain static, even if the website has changed and if the user has performed the actions required at the website.

### SUMMARY OF THE INVENTION

The different embodiments provide a computer implemented method, apparatus, and computer usable program code for modifying a visual appearance of bookmarks in an Internet browser. A bookmark and a state corresponding to a website are obtained. The bookmark is placed in a folder associated with the Internet browser based on the state. Responsive to a user visiting the website and performing an action, the visual appearance of the bookmark in the folder is modified based on the state and the action.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a user interaction with websites in accordance with an illustrative embodiment;

FIG. 4 is a block diagram of bookmark hierarchy in accordance with an illustrative embodiment; and

FIG. 5 is a flowchart for modifying how a bookmark appears in accordance with an illustrative embodiment.

### DETAILED DESCRIPTION OF THE PREFERRED EMBODIMENT

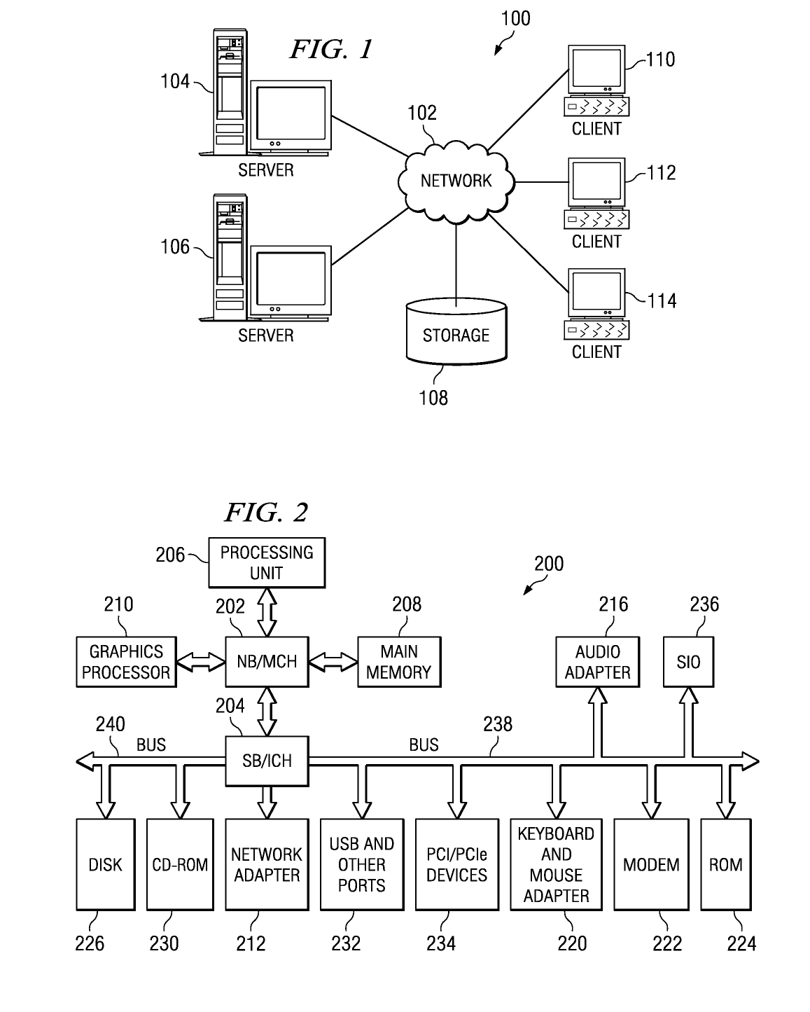

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

On the Internet, a website address is specified using a unique universal resource locator (URL). When a user visits a specific website and the user desires to return to that website at a later time, the user typically bookmarks the website by placing the universal resource locator for that website in a special folder for bookmarks.

Users are often interested when the contents of a website have changed, and many websites allow the user to be notified when the content of the website has changed. Typically, the user is notified that the website has changed by sending the user an email. However, if the user has asked to be notified of changes to numerous websites, the user may become inundated with email notifications.

When a website changes, the user may be required to take specific actions. For example, a user who has a brokerage account for buying and selling stocks on the stock market may be required to acknowledge having read a user agreement. If the terms of the agreement change, then the user must re-acknowledge having read the new terms of the user agreement. Similarly, a corporation may ask employees to acknowledge having read a new or changed corporate policy, such as business conduct guidelines posted on a website. However, as previously mentioned, notifying the user to acknowledge having read various corporate policies posted on various websites each time the policies change may result in the user being inundated with email notifications.

The embodiments recognize that when a website changes, it would be useful if the user's browser obtains one or more bookmarks in a bookmark folder, and as the user completes the tasks required by the website corresponding to each bookmark, the appearance of the bookmarks is modified to visually indicate the state of the website and the relationship of the user to the website.

The different embodiments provide a computer implemented method, apparatus, and computer usable program code for modifying a visual appearance of bookmarks in an Internet browser. A bookmark and a state corresponding to a website are obtained. The bookmark is placed in a first folder associated with the Internet browser based on the state. Responsive to a user visiting the website and performing an action, the visual appearance of the bookmark in the first folder is modified based on the state and the action.

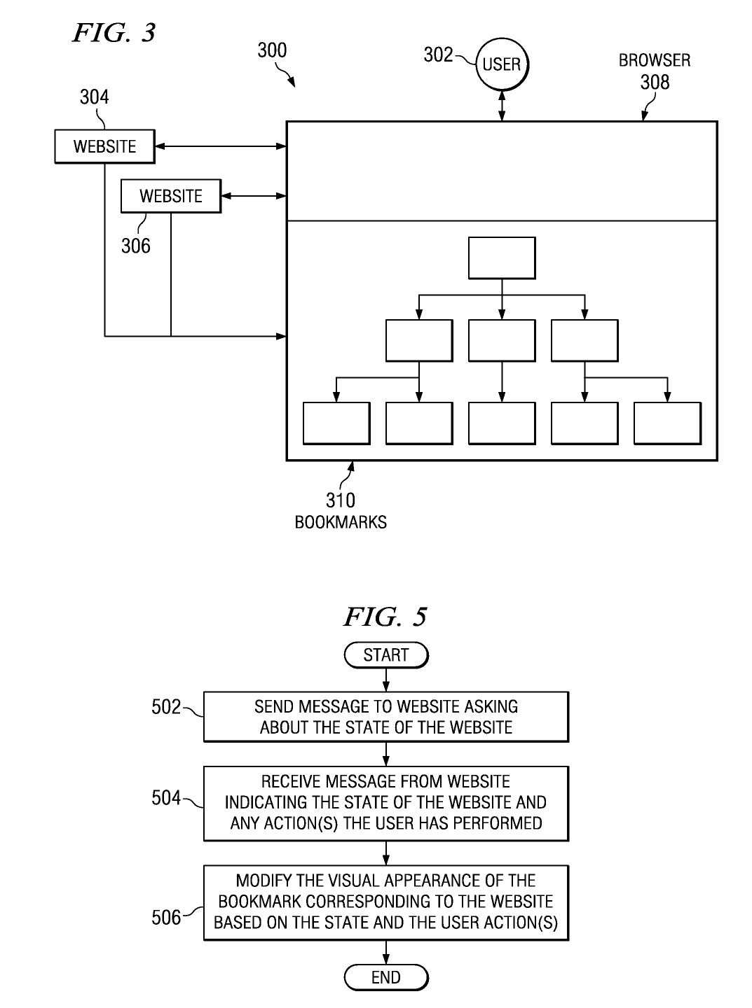

With reference now to FIG. 3, a block diagram of a user interaction with websites, in accordance with an illustrative embodiment, is depicted. In user interaction with websites 300, user 302 interacts with websites 304 and 306. User 302 interacts with websites 304 and 306 using browser 308. Browser 308 has an associated set of bookmarks, bookmarks 310. Browser 308 may be software running on a computer, such as client 110 in FIG. 1.

Typically, bookmarks 310 contains one or more bookmarks and folders, with the bookmarks and folders arranged in a hierarchical tree structure. For example, the bookmarks and folders within bookmarks 310 may, at the highest level, contain a work folder and a fun folder. The work folder may contain bookmarks of websites for work-related activities, and the fun folder may contain bookmarks of websites for non-work related activities. In this way, different bookmarks may be organized by grouping related bookmarks into a folder or grouping related folders and bookmarks into a folder.

When a user's employer adds a new website or changes an existing website, the user may be required to visit the website and perform some action, such as read new guidelines and electronically acknowledge having read the guidelines. One way for the user to be notified that the user must take action is to send the user an email each time the user is required to visit a specific website. However, this may result in the user receiving many emails.

To obtain the bookmarks of the websites which user 302 needs to visit and perform an action on, browser 308 may poll a set of websites, such as website 304 and website 306. In polling a set of websites, each bookmark in a specific set of bookmarks, such as bookmarks 310, is used to send a message to the corresponding website, such as website 304. The message provides the identity of user 302, and the message asks whether the user needs to visit that website and perform an action. Each website which is sent a message then sends a message to browser 308 indicating whether or not user 302 needs to visit the website and perform an action.

Alternately, website 304 and website 306 may send browser 308 the websites which user 302 needs to visit. For example, website 304 may send a bookmark of website 304, indicating that the user should visit website 304.

Browser 308 displays the bookmarks and changes how the bookmarks appear visually based on the state of the website, such as website 304 or 306, and what actions the user has performed at the website. The term “state of the website” means whether or not the website has been modified since the user last visited the website. For example, the bookmark may appear red when a specific website has changed and the user has not yet visited the website. When the user visits the website, but has not completed all the tasks the user needs to at that website, then the bookmark may appear yellow. Finally, when the user has completed the tasks required of the user at that website, then the bookmark may be visually displayed as a green bookmark or may not be visible in the bookmarks folder.

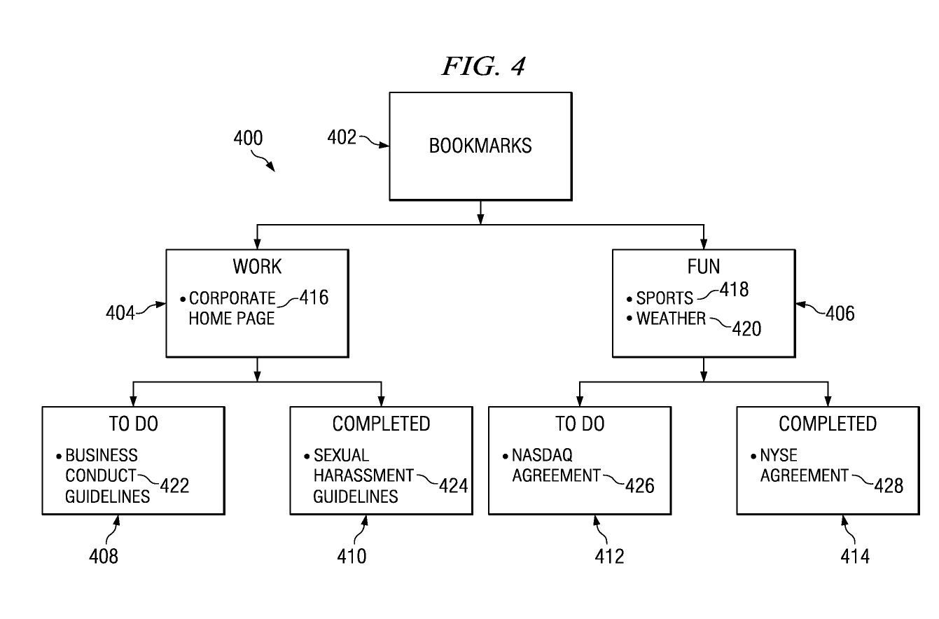

With reference now to FIG. 4, a block diagram of bookmark hierarchy, in accordance with an illustrative embodiment, is depicted. Bookmark hierarchy 400 is an example of the contents of a bookmark folder, such as bookmarks 310 in FIG. 3.

In this example, bookmarks 402, work 404, fun 406, to do 408, completed 410, to do 412, and completed 414 are folders arranged in a hierarchical structure. Each folder may contain folders, bookmarks, or a combination of folders and bookmarks. For example, work 404 contains corporate home page 416, the universal resource locator for the user's company's intranet homepage.

Similarly, fun 406 contains bookmarks sports 418 and weather 420. Sports 418 may be a universal resource locator for a website that provides sports information, such as, for example, a website with a domain of nfl.com. Similarly, weather 420 may be a universal resource locator for a website that provides weather information.

When a user's employer adds a new website or changes an existing website, the user may be required to visit the website and perform an action. For example, the user may be required to read the new or modified guidelines and electronically acknowledge having read the guidelines, or the user may be required to read the new or modified guidelines and take a short multiple choice quiz to demonstrate that the user has read the guidelines. Because a web browser, such as browser 308 of FIG. 3, is used to visit the websites and, if required, perform an action on the websites, the browser can change the visual appearance of the bookmark or remove the bookmark for the website. The visual appearance of the bookmark is altered based on the state of the website and what actions the user has performed at that website.

In this example, the user's employer has bookmark business conduct guidelines 422 and bookmark sexual harassment guidelines 424. The user is required to go to the websites for business conduct guidelines 422 and sexual harassment guidelines 424 and perform one or more actions. The browser obtains bookmark business conduct guidelines 422 and bookmark sexual harassment guidelines 424 either by polling the corresponding websites and determining that the websites have changed or by receiving the bookmarks from the websites.

The bookmarks for those websites which the user has not visited are stored in a first folder, such as to do 408. Once the user has visited the website and performed the required action or actions, the browser may change the appearance of the bookmark or remove the bookmark from folder to do 408. Optionally, if the bookmark has been removed from the first folder containing websites which the reader has not visited, then the browser may place the bookmark in a second folder, such as completed 410, to indicate that the user has visited the website. Optionally, the browser may remove the bookmark from the second folder once a specific period of time has lapsed.

In this example, the bookmark business conduct guidelines 422 is in folder to do 408, indicating that the user has not yet completed all the actions the user is required to perform at the website corresponding to bookmark business conduct guidelines 422. The bookmark sexual harassment guidelines 424 is in folder completed 410, indicating that the user has completed visiting the website corresponding to bookmark sexual harassment guidelines 424.

Similarly, the user may have a stock trading account with an Internet-based stock broker. The stock broker may buy and sell stock on one or more stock exchanges. Each stock exchange may require that clients abide by the stock exchange's rules, and therefore, each stock exchange may require that each client read and acknowledge having read the stock exchange's rules.

In this example, the user has yet to read and acknowledge reading the user agreement for the NASDAQ stock exchange because bookmark NASDAQ agreement 426 is in folder to do 412. The user has however read and acknowledged reading NYSE agreement 428, because bookmark NYSE agreement 428 is in folder completed 414.

FIG. 5 is a flowchart for modifying how a bookmark appears in accordance with an illustrative embodiment. The process illustrated in this flowchart is executed by software, such as browser 308 in FIG. 3. The process begins by optionally polling a website (step 502). A website may be polled, for example, by sending a message to the website corresponding to a bookmark in a folder.

A message is received from a website indicating the state of the website and any action(s) which the user has performed at the website (step 504). If the website was polled, the website may send the message in response to the message sent in step 502. If the website was not polled, then the website may send the message because the state of the website changed since the last visit of the user or because the user visited the website and performed one or more actions. For example, the state of the website may change if new content, which the user has yet to review, is added to the website. The software process modifies the visual appearance of the bookmark based on the state of the website and any action the user has performed (step 506) and the process ends.

For example, suppose the content of the website changes, requiring the user to visit the website. The browser may modify the appearance of the bookmark to a red color to indicate that the state of the website requires the user to visit the website. If the user visits the website and performs some actions but does not complete all the actions the user is required to perform, then the browser may modify the appearance of the bookmark to a yellow color. When the user visits the website and completes all the actions, the browser may modify the appearance of the bookmark to a green color. Those versed in the art will appreciate that the browser may modify the appearance of bookmarks in many different ways, such as by changing the font used to display the bookmark.

The different embodiments provide a computer implemented method and apparatus for modifying a visual appearance of bookmarks in an Internet browser. A bookmark and a state corresponding to a website are obtained. The bookmark is placed in a first folder associated with the Internet browser based on the state. Responsive to a user visiting the website and performing an action, the visual appearance of the bookmark in the first folder is modified based on the state and the action.

The illustrative embodiments allow the user to determine from the visual appearance of a bookmark in the bookmarks folder the state of each website and the actions which the user has performed at each website.

For example, a red bookmark may indicate that the website has changed and the user should visit the website. A yellow bookmark may indicate that the website has changed and the user has visited the website, but the user has not completed all the actions which the user should do at the website. Once the user has completed all the actions required, the bookmark may be removed from the folder into which the bookmark was initially placed.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for modifying a visual appearance of a bookmark in an Internet browser, the computer implemented method comprising:
determining a state of a website for the bookmark, wherein the bookmark is stored in a folder;
setting a visual appearance for the bookmark based on the state of the website; and
responsive to a user visiting the website and performing an action, modifying the visual appearance of the bookmark in the folder based on the state of the website and the action.

2. The computer implemented method of claim 1, wherein modifying the visual appearance of the bookmark comprises one of changing a color of the bookmark, or changing a font of the bookmark, or presenting an alternate graphical image adjacent to the bookmark.

3. The computer implemented method of claim 1, further comprising:
removing the bookmark from the folder; and
placing the bookmark in another folder associated with the Internet browser.

4. The computer implemented method of claim 3, further comprising:
removing the bookmark from the another folder after a specified period of time.

5. The computer implemented method of claim 1, wherein obtaining the bookmark corresponding to the website comprises:
receiving the bookmark from the website using the Internet browser.

6. The computer implemented method of claim 1, wherein obtaining the bookmark corresponding to the website comprises:
sending a query to the website; and
responsive to sending the query to the website, receiving the bookmark and the state of the website, wherein the state determines whether the visual appearance of the bookmark should be modified.

7. A data processing system for modifying a visual appearance of a bookmark in an Internet browser, the data processing system comprising:
a bus;
a storage device connected to the bus;
a communications unit connected to the bus;
a processing unit connected to the bus;
a state of a website for the bookmark, wherein the bookmark is stored in a folder; and
the Internet browser, wherein the Internet browser sets the visual appearance for the bookmark based on the state of the website, and responsive to a user visiting the website and performing an action, modifies the visual appearance of the bookmark in the folder based on the state of the website and the action.

8. The data processing system of claim 7, wherein the Internet browser modifies the visual appearance of the bookmark by one of changing a color of the bookmark, or changing a font of the bookmark, or presenting an alternate graphical image adjacent to the bookmark.

9. The data processing system of claim 7, wherein the Internet browser places the bookmark in another folder associated with the Internet browser.

10. The data processing system of claim 9, wherein the Internet browser removes the bookmark from the another folder after a specified period of time.

11. The data processing system of claim 7, wherein the Internet browser obtains the bookmark corresponding to the website by receiving the bookmark from the website.

12. The data processing system of claim 7, wherein the Internet browser obtains the bookmark and the state corresponding to the website by sending a query to the website, and responsive to sending the query, the Internet browser receives the bookmark and the state of the website, wherein the state determines whether the website is new or modified.

13. A computer program product comprising a computer usable medium including computer usable program code for modifying a visual appearance of a bookmark in an Internet browser, the computer program product comprising:
a state of a website for the bookmark, wherein the bookmark is stored in a folder;
computer usable code for setting the visual appearance for the bookmark based on the state of the website; and
responsive to a user visiting the website and performing an action, computer usable code for modifying the visual appearance of the bookmark in the folder based on the state of the website and the action.
